(19) United States
(12) Patent Application Publication
(10) Pub. No.: US 2026/0342161 A1
(43) Pub. Date: Oct. 29, 2026

(54) Coil Component for an Electric Machine of a Motor Vehicle, and Method for Producing a Coil Component

(71) Applicant: Bayerische Motoren Werke Aktiengesellschaft, Muenchen (DE)

(72) Inventors: Matthias BLUEMEL, Herrngiersdorf (DE); Juergen HUETTINGER, Pappenheim (DE)

(21) Appl. No.: 19/113,567

(22) PCT Filed: Oct. 26, 2023
(86) PCT No.: PCT/EP2023/079865

§ 371 Date: Mar. 20, 2025

(30) Foreign Application Priority Data
Nov. 16, 2022 (DE) 10 2022 130 338.1

(51) Int. Cl. H02K 3/34; H02K 15/108

(52) U.S. Cl. CPC H02K 3/345; H02K 15/108

(57) ABSTRACT

A coil component for an electric machine of a motor vehicle, having a support having grooves slots distributed in the circumferential direction of the carrier and extending in the axial direction, a plurality of hairpins at least partially arranged in the grooves, and at least one insulating element arranged a groove that electrically insulates the hairpins from a groove wall, wherein the insulating element is supported against the slot wall by a wedge-shaped geometry, as a result of which a force acting on the wedge-shaped geometry in the axial direction is converted into a force that acts in the circumferential direction, and by way of which the insulating element is pressed onto the hairpins in the circumferential direction.

### BACKGROUND AND SUMMARY

The invention relates to a coil component for an electric machine of a motor vehicle and to a method for producing a coil component for an electric machine of a motor vehicle.

WO 2022/033627 A1 discloses a coil component for an electric machine, having a support and a coil winding, at least certain portions of which are received in the support. The support has an annular region having a plurality of grooves, which are arranged so as to be distributed in a circumferential direction, wherein a plurality of winding portions of the coil winding are received in each groove. In at least one groove, an insulation layer is arranged between the support and the winding portions and protrudes beyond the winding portions, by way of two extension portions, toward a radial opening of the at least one groove. In the at least one groove equipped with the insulation layer, a closure element is received, toward the radial opening, in the support, wherein the two extension portions are designed and arranged in such a manner that the closure element is spaced apart from the support by the extension portions.

It is already known that stator grooves are insulated using surface insulation material. After a winding has been installed, it is impregnated with a synthetic resin, in order to fix the winding in the stator, to improve the transfer of heat to the laminated core and to increase resistance to partial discharge. However, an enamel insulation of the stator winding is incompatible with this impregnating resin. In the case of trickle impregnation, impregnating resin can reach the winding heads of the stator. This can result in failure of the enamel insulation of the winding there.

An object of the present invention is to provide a solution that is used to particularly effectively electrically insulate a coil of a coil component with respect to a support and that can be used to prevent an enamel insulation of the coil from failing.

This object is achieved according to the invention by the subject matter of the independent claims. Further possible configurations of the invention are disclosed in the dependent claims, the description and the figures. Features, advantages and possible configurations that are presented in the context of the description for one subject matter of the independent claims should be considered at least analogously as features, advantages and possible configurations of the respective subject matter of the other independent claims and of any possible combination of the subject matter of the independent claims, optionally in conjunction with one or more of the dependent claims.

The invention relates to a coil component for an electric machine of a motor vehicle. The coil component can be a rotor or a stator for the electric machine. This electric machine is in particular a fraction machine that can be used to electrically drive the motor vehicle. The coil component comprises a support, which has a multiplicity of grooves, which are arranged so as to be distributed in the circumferential direction of the support and extend in the axial direction. The support can comprise, for example, a laminated core consisting of a multiplicity of laminations stacked one on top of the other in a stacking direction or be produced in one piece, for example, during a sintering process. The coil component additionally comprises a plurality of hairpins, at least certain portions of which are arranged in the grooves. These hairpins can also be referred to as plug-in coils. These hairpins can be enameled flat copper wires, which are bent in a U-shaped manner and are plugged into the grooves of the support. Alternatively, the hairpins can be designed as I-pins and thus as straight flat copper wire elements. The entirety of the hairpins of the coil component forms a coil of the coil component. This means that the coil comprises all the hairpins of the coil component, wherein the hairpins are plugged into the grooves of the support. In particular, at least one hairpin is arranged in each groove of the support. In particular, a plurality of hairpins are arranged in each groove of the support.

The coil component further comprises at least one insulating element, which is arranged in one of the grooves and is used to electrically insulate the hairpins arranged in this groove from a groove wall, which delimits the groove, of the support. In particular, the coil component comprises a plurality of insulating elements, wherein at least one insulating element, which is used to insulate the hairpins arranged in this groove from a groove wall, which delimits this groove, of the support, is arranged in each of the grooves of the support. In order to guarantee a particularly effective transfer of heat from the hairpins to the support, provision is made for the insulating element to be supported against the groove wall of the support by way of a wedge geometry. A force acting on the wedge geometry in the axial direction of the support is converted, by way of the wedge geometry, into a force acting in the circumferential direction of the support, this force being used to press the insulating element onto the hairpins in the circumferential direction. The axial direction of the support coincides in particular with an axis of rotation of the rotor or a central axis of the stator as coil component. The circumferential direction coincides with a rotational direction of the rotor relative to the stator in the electric machine. The wedge geometry thus causes the at least one insulating element to be clamped in the groove, as a result of which the at least one insulating element is placed particularly close to and in particular flat onto the hairpins. This can make particularly effective heat dissipation possible from the hairpins to the support by way of the insulating element. This particularly effective transfer of heat makes particularly effective cooling of the hairpins possible, as a result of which overheating of the hairpins can be particularly effectively prevented. Consequently, the electric machine can be operated particularly efficiently and at a particularly high power.

In one possible configuration of the invention, provision is made for the insulating element to have the wedge geometry, so that two side faces of the insulating element converge at an acute angle. In other words, the wedge geometry of the insulating element comprises a first face and a second face oriented obliquely thereto, which converge in the axial direction and in particular adjoin one another at a pointed edge. By virtue of the insulating element itself having the wedge geometry, particularly few component parts are required in the coil component in order to both electrically insulate the hairpins from the support and place the insulating component particularly close to the hairpins. This enables the coil component to be produced particularly easily.

In one possible development of the invention, provision is made for the insulating element to have a U-shaped cross section. In this case, the U shape of the cross section occurs when the insulating element is in a state in which it is plugged into a groove of the support in the axial direction, in particular in the case of a section running perpendicular to the axial direction through the insulating element. This U-shaped cross section of the insulating element enables the insulating element to be used to electrically insulate at least one of the hairpins arranged in this groove, in particular all the hairpins arranged in this groove, at least on three sides. This enables the hairpins to be electrically insulated with respect to the support over a particularly large area using the insulating element.

In another possible configuration of the invention, provision is made for, in a groove, a plurality of insulating elements to be arranged one above the other in the axial direction and to be partially plugged into one another, as a result of which the respective insulating elements bear against one another by way of their respective wedge geometries. The wedge geometries of the insulating elements arranged in a common groove that bear against one another enable the insulating elements to be mutually clamped within the groove, as a result of which one of the insulating elements presses another of the insulating elements in the same groove particularly firmly against the hairpins arranged in this groove.

In this connection, provision can in particular be made for provision to be made in the groove for two insulating elements, the respective arms of the U-shaped cross section of which are oriented toward one another, as a result of which the insulating elements jointly enclose a channel, which runs in the axial direction and through which the hairpins extend. This means that the hairpins are plugged into the channel, which runs with its direction of longitudinal extent in the axial direction of the support, as a result of which the hairpins arranged in a common groove are reliably circumferentially electrically insulated relative to the support by the two insulating elements. In other words, the respective open sides of the U-shaped cross section of the insulating elements are oriented toward one another, so that the arms and the backs of the insulating elements jointly circumferentially delimit the channel.

In another possible configuration of the invention, provision can be made for the insulating element to have at least one straight portion, which runs in the axial direction and has a constant wall thickness, and at least one wedge geometry, which adjoins the straight portion in the axial direction. The insulating element can have, for example, in its state in which it is plugged into the groove, the straight portion in the center and have the wedge geometry adjoining the straight portion upward in the axial direction and another wedge geometry adjoining the straight portion downward in the axial direction. This enables the insulating element to be wedged in each case with another insulating element both upward in the axial direction and downward in the axial direction. Therefore, in the groove, a plurality of insulating elements can be arranged one above the other in the axial direction and be wedged together by way of their respective wedge geometries. This enables particularly easy injection molding of the respective insulating elements since they can be produced with a particularly stable length that can be particularly easily produced during the injection molding. Simply as many of the insulating elements are arranged one above the other in the axial direction as are needed to electrically insulate the hairpins arranged in the groove from the support over the entire length of the groove using respective insulating elements. This makes it possible both to produce the insulating elements particularly easily with a particularly high stability and to particularly safely electrically insulate the hairpins with respect to the support.

In another possible configuration of the invention, provision is made for the at least one insulating element to have a stop, which can abut against an end side of the support and specifies an axial end position of the insulating element. If the coil component has a plurality of insulating elements, then at least one of these insulating elements or at most two of the insulating elements can have this stop, wherein the first of these insulating elements abuts, by way of the stop, against a first end side of the support and the second insulating element abuts, by way of its stop, against the second end side, which is opposite the first end side, of the support. The insulating element having the stop ensures, when the stop abuts against the end side of the support, that the hairpins in the associated groove are electrically insulated with respect to the support, at the end of the groove on which this insulating element is arranged, all the way up to the end face. This ensures that the hairpins arranged in the groove are electrically insulated with respect to the support all the way up to the edge of the groove and the insulating element does not slide into the groove and thus establishes electrical contact between the hairpins and the support on an outer edge of the groove.

In one possible development of the invention, provision is made for the insulating element to be pressed onto the hairpins using a separate groove insulation wedge having the wedge geometry. This means that the insulating element does not have the wedge geometry. For example, the insulating element can be a piece of groove insulation paper. This groove insulation paper can have a constant thickness over its entire height running in the axial direction. The groove insulation wedge having the wedge geometry can be used to press the groove insulation paper onto the hairpins. For this purpose, the groove insulation wedge is plugged in and clamped between the support and the insulating element, as a result of which the insulating element is placed, and in particular pressed, directly onto the hairpins. This enables the hairpins to be insulated using the groove insulation paper in a manner that is particularly easy to produce, wherein it is ensured that the groove insulation paper is placed onto the hairpins over a large area and that a gap between the groove insulation paper and the support is filled by the at least one groove insulation wedge. Potting a gap between the groove insulation paper and the support with impregnating resin can thus be dispensed with.

In order to make it easier to insert the wedge-shaped geometry between the support and the hairpins, the support can have an insertion bevel.

The invention additionally relates to a method for producing a coil component for an electric machine of a motor vehicle. The electric machine comprises a support, which has a multiplicity of grooves, which are arranged so as to be distributed in the circumferential direction of the support and extend in the axial direction. The coil component can be, for example, a rotor or a stator of the electric machine. In the context of the method, in particular a coil component as has already been described in connection with the coil component according to the invention is produced. In the case of the method, provision is made for a plurality of hairpins and at least one insulating element to be arranged, at least in certain portions, in the grooves, wherein the at least one insulating element is used to electrically insulate the hairpins from a groove wall, which delimits the groove, of the support. In particular, in the case of the method, a plurality of hairpins and at least one insulating element are plugged into each of the grooves of the support. In the case of the method, provision is further made for the at least one insulating element to be supported against the groove wall of the support by way of a wedge geometry, as a result of which a force acting on the wedge geometry in the axial direction is converted into a force acting in the circumferential direction, this force being used to press the insulating element onto the hairpins in the circumferential direction. Pressing the insulating element onto the hairpins produces a particularly large contact surface between the hairpins and the insulating element, as a result of which heat can be dissipated particularly efficiently from the hairpins toward the support by way of the insulating element. This enables the hairpins to be cooled particularly efficiently. It is possible that the insulating element has the wedge geometry or that the insulating element does not have any wedge geometry and a groove insulation wedge, which has the wedge geometry and is used to press the insulating element onto the hairpins, is additionally arranged in the groove. The method makes it possible for use of an impregnating resin for electrically insulating the hairpins from the support to be able to be dispensed with. Consequently, a risk of an enamel insulation of the coil failing on account of impregnating resin contacting the enamel insulation can be eliminated. This enables a particularly long service life of the coil component to be achieved.

In the case of the coil component according to the invention or in the case of the method, the impregnating resin is omitted and use is instead made of a multi-part plastics groove insulation having a wedge-shaped longitudinal wall section, which clamps, and thus fixes, the hairpins in the support, in particular in a laminated core, by the hairpins and support being plugged into one another.

Further features of the invention can be gathered from the claims, the figures and the description of the figures. The features and combinations of features mentioned above in the description and the features and combinations of features below in the description of the figures and/or shown in the figures alone can be used not only in the respectively specified combination but also in other combinations or on their own without departing from the scope of the invention.

### BRIEF DESCRIPTION OF THE DRAWINGS

FIG. 1 shows a schematic sectional view of a region of a coil component of an electric machine in a first embodiment;

FIG. 2 shows an exploded illustration of hairpins arranged in a groove of a support of the electric machine and two insulating elements arranged in this groove according to the embodiment from FIG. 1;

FIG. 3 shows a schematic perspective view of a region of the coil component of the first embodiment;

FIG. 4 shows a schematic sectional view of a region of the coil component in a second embodiment;

FIG. 5 shows an exploded illustration of a region of the coil component of the second embodiment;

FIG. 6 shows a schematic sectional view of a region of the coil component in a third embodiment; and

FIG. 7 shows an exploded illustration of a region of the coil component of the third embodiment.

### DETAILED DESCRIPTION OF THE DRAWINGS

In the figures, elements that are identical and functionally identical are provided with the same reference signs.

The figures show a coil component 10 for an electric machine of a motor vehicle. This electric machine is in particular a traction machine for the motor vehicle, which can be used to drive the motor vehicle using electrical energy. In the present case, the coil component 10 is a stator of the electric machine. In particular, the stator is a hairpin stator.

This hairpin stator comprises a support 12, which is designed as a laminated core in the present case. This support 12 has a multiplicity of grooves 14, which are arranged so as to be distributed in the circumferential direction U of the support 12 and extend with their direction of longitudinal extent in the axial direction A of the support 12. The coil component 10 additionally comprises a plurality of hairpins 16, which are respective phase wires and are plugged into the grooves 14 of the support 12. The entirety of the hairpins 16 forms a coil. Each of the hairpins 16 extends over an entire length, running in the axial direction A, of the associated groove 14. In the present case, a plurality of hairpins 16 are arranged one next to the another in each groove 14. In this case, the hairpins 16 are arranged one behind the other in a. line in the radial direction R of the support 12. The radial direction R is perpendicular to the axial direction A. In order to electrically insulate the hairpins 16 arranged in the grooves 14 of the support 12 from the support 12, provision is made for at least one insulating element per groove 14 or a plurality of insulating elements per groove 14, the insulating elements being used to electrically insulate the hairpins 16 from the support 12.

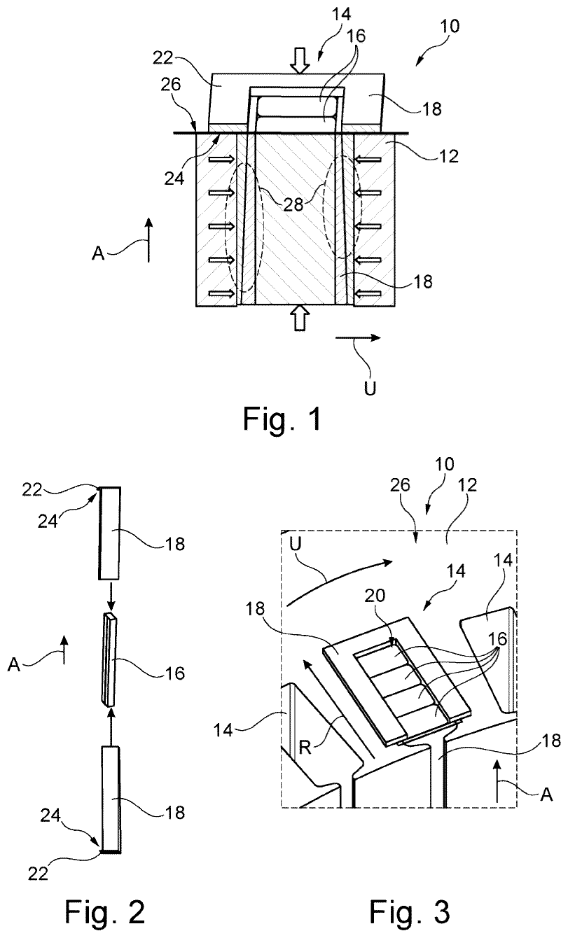

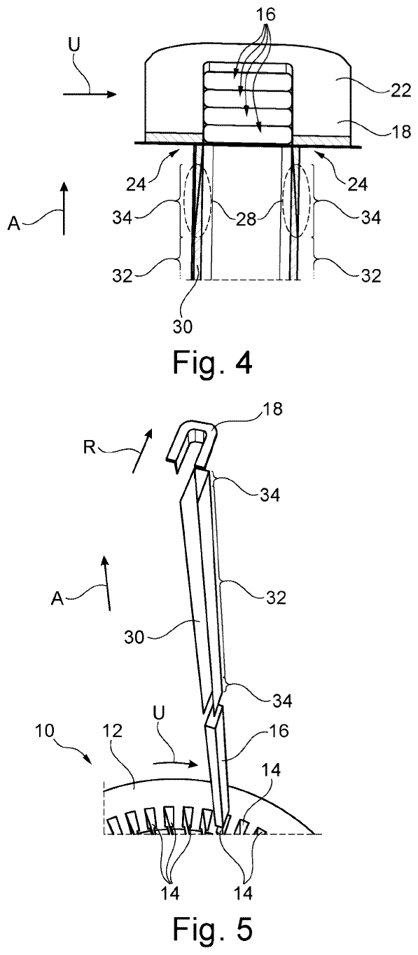

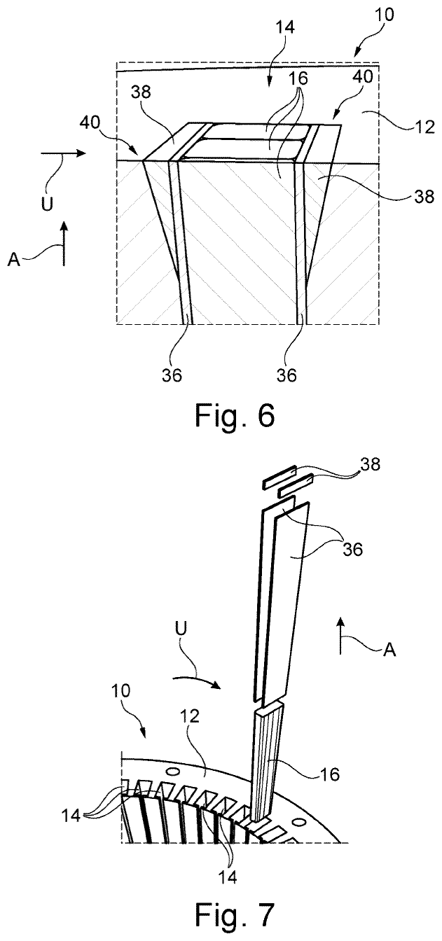

FIGS. 1, 2 and 3 show the coil component 10 in a first embodiment, FIGS. 4 and 5 show the coil component 10 in a second embodiment, and FIGS. 6 and 7 show the coil component 10 in a third embodiment. The embodiments differ in particular in terms of the configuration of the respective insulating elements. What all the embodiments have in common is that the respective insulating elements are clamped against the support 12 by way of at least one wedge-shaped geometry, as a result of which the insulating elements are placed particularly close to and in particular over a particularly large area onto the hairpins 16. This makes a particularly effective transfer of heat from the hairpins 16 to the respective insulating elements possible, as a result of which the hairpins 16 can in turn be cooled particularly effectively during operation. Therefore, what all the embodiments have in common is that at least one insulating element, which is used to electrically insulate the hairpins 16 arranged in this groove 14 from a groove wall, which delimits the groove 14, of the support 12, is arranged in each of the grooves 14, wherein the insulating element is supported against the groove wall of the support 12 by way of a wedge geometry. As a result, a force acting on the wedge geometry in the axial direction A is at least partially converted into a force acting in the circumferential direction U, this force being used to press the insulating element onto the hairpins 16 in the circumferential direction U. The pressing acting in the circumferential direction allows tolerances to be compensated for.

What the embodiments shown in FIGS. 1 to 5 have in common is that the at least one insulating element has the wedge geometry. In the case of the third embodiment shown in FIGS. 6 and 7, the insulating element does not have the wedge geometry, but rather provision is made in the respective groove 14 for at least one groove insulation wedge 38, which is formed separately to the insulating element, has the wedge geometry, and is used to press the insulating element onto the hairpins 16.

In the case of the first embodiment of the coil component 10 shown in FIGS. 1 to 3, provision is made for the coil component 10 to have two first insulating elements 18. In the case of a cross section running perpendicular to the axial direction A, the first insulating elements 18 have a U shape. In the groove 14, in which the first insulating elements 18 are arranged, as can be seen particularly well in FIG. 3, the two first insulating elements 18 are oriented with their respective arms of the U-shaped cross section toward one another. This results in the two first insulating elements 18 jointly circumferentially enclosing a channel 20, which runs in the axial direction A, in the groove 14. All the hairpins 16 associated with this groove 14 are arranged in this channel 20. As a result, the hairpins 16 arranged in the channel 20 are completely circumferentially electrically insulated with respect to respective groove walls, which delimit the groove 14, of the support 12 by the two first insulating elements 18. This enables electrically conducting contact between the hairpins 16 and the support 12 to be particularly reliably prevented.

As can be seen particularly well in FIG. 1, the first insulating element 18 has, at its one end, a collar 22, which is used to provide a stop 24. The collar 22 rests against a first end side 26 of the support 12, as a result of which the stop 24 abuts against the first end side 26 of the support 12. The stop 24 abutting against the first end side 26 of the support 12 specifies an axial end position of the first insulating element 18 in the groove 14. It is clear from FIG. 2 that each of the two first insulating elements 18 of the first embodiment has a collar 22 having a stop 24. The further first insulating element 18 can bear, by way of its collar 22, against a second end side, which is opposite the first end side 26 and is not shown in the figures, of the support 12, as a result of which the further first insulating element 18 abuts, by way of its stop 24, against this second end side and as a result an axial end position is specified for the further first insulating element 18 as well. These specified axial end positions of the first insulating elements 18, or the collars 22 of the first insulating elements 18 being placed onto the opposite end sides of the support 12, ensures that the first insulating elements 18 are used to electrically insulate the hairpins 16 in the respective grooves 14 with respect to the support 12 over an entire length of the grooves 14 in the axial direction A through the channel 20 formed by the first insulating elements 18. A risk of a flow of current between the hairpins 16 and the support 12 can thus be kept particularly low.

In order to ensure that at least one of the first insulating elements 18 is placed particularly flat onto the hairpins 16 and that air gaps between the hairpins 16 and the groove wall, which delimits the groove 14, of the support 12, are prevented or reduced, the first insulating elements 18 each have a wedge geometry 28. As can be seen in FIG. 1, an upper, in the axial direction A, first insulating element 18 can have a wedge-shaped inner contour, whereas the lower, in the axial direction A, first insulating element 18 has a wedge-shaped outer contour. The wedge-shaped inner contour of the upper first insulating element 18 bears against the wedge-shaped outer contour of the lower first insulating element 18. In the case of a force acting in the axial direction A on one of the first insulating elements 18 toward the further first insulating element 18, the wedge-shaped geometries of the first insulating elements 18 are moved along one another. This causes, as a result of the principle of the inclined plane, the force acting in the axial direction A to be converted into a force acting in the circumferential direction at least partially by the wedge-shaped geometries, as a result of which the first insulating elements 18 are pressed onto one another and onto the groove wall and onto the hairpins 16. Consequently, air gaps in the groove 14 filled with the hairpins 16 can be reduced or in particular completely eliminated. This makes a particularly effective transfer of heat from the hairpins 16 to the support 12 possible.

In the case of the first embodiment, use is thus made of two first insulating elements 18 in the form of two U-shaped sleeves having a wedge-shaped geometry on the inner contour or on the outer contour. An axial force is converted into a tangential force by way of the wedge geometry. This results in surface pressure between the wedge-shaped regions of the first insulating elements 18, the support 12, which is in particular designed as a laminated core, and the phase wires and thus the hairpins 16, when installed in the axial end position. In the case of the respective first insulating elements 18, the wedge geometry can be implemented by tapering the wall thickness over the course of the axial direction A and optionally additionally by tapering the wall thickness in the radial direction R. It is thus possible for the first insulating elements 18 to be wedged together in the circumferential direction U. In the present case, the insulating elements of the first embodiment and of the second embodiment are produced from an electrically insulating plastic.

For the installation of the coil component 10, in the case of the first embodiment, the sleeve-shaped first insulating elements 18 are plugged into the grooves 14 of the support 12 in the axial direction A. Depending on the axial position of the sleeves, a tangential dimension between the sleeves and the phase wires can be adjusted. There is surface pressure between the wedge-shaped regions of the first insulating elements 18, the laminated core and the phase wires, when installed in the end position, which results in a high tangential force. The coil component 10 of the first embodiment can be disassembled again, can be produced in a short cycle time, does not comprise any potting resin, has a very high degree of groove filling and makes it possible for the phase wires to be centered in the groove 14.

In the case of the second embodiment, which is shown in FIGS. 4 and 5, provision is made for at least one first insulating element 18 and at least one second insulating element 30 to be arranged in the groove 14. The first insulating element 18 has the collar 22 providing the stop 24, as a result of which the axial end position of the first insulating element 18 is specified. The second insulating element 30 has a straight portion 32, which runs in the axial direction A, and two wedge portions 34, each of which adjoins the straight portion 32 upward and downward in the axial direction A. The wedge portions 34 have the wedge geometry. In the case of a cross section of the second insulating element 30 running perpendicular to the axial direction A, this second insulating element 30 has a U-shaped cross section. In this case, when the second insulating element 30 is in the state in which it is plugged into the groove 14, the arms of this U-shaped cross section are oriented radially in the same direction as the arms of the U-shaped cross section of the first insulating element 18. This means that the U-shaped cross sections of the first insulating element 18 and of the second insulating element 30 point with their opening in the same direction. In the case of a longitudinal section running in the axial direction A and perpendicular to the radial direction R through one of the arms of the U-shaped cross section of the second insulating element 30, this longitudinal section has a trapezoidal geometry having opposite sides oriented parallel to one another. This means that, in the present case, the second insulating element 30 has a constant wall thickness in the straight portion 32, whereas the wall thickness of the second insulating element 30, in the wedge portions 34 for providing the wedge-shaped geometry, tapers toward respective ends, in the present case an upper, in the axial direction A, end and a lower, in the axial direction A, end.

In the second embodiment, a plurality of second insulating elements 30 can be arranged one above the other in the axial direction A in a respective groove 14 in order to ensure that the hairpins 16 are electrically insulated with respect to the support 12 by respective insulating elements over the entire length, running in the axial direction A, of the groove 14. For example, in the groove 14, a first insulating element 18 can be arranged right at the top in the axial direction, one or more second insulating elements 30 can subsequently follow in the axial direction A and a first insulating element 18 can be arranged further below in the axial direction. Respective insulating elements, which are arranged one above the other in the axial direction A, bear with their wedge geometries against one another in order, by way of the principle of the inclined plane, by an axial force being applied, to make it possible for the insulating elements to be pressed together and with the phase wires designed as hairpins 16 and respective groove walls delimiting the groove 14. The configuration of the insulation in the groove 14 with the plurality of second insulating elements 30 makes it possible for these second insulating elements 30 and the at least one first insulating element 18 to be able to be injection molded particularly easily, since a length, running in the axial direction A, of the respective insulating elements can be adjusted for an injection molding process. This means that the lengths of the insulating elements are selected in such a manner that the latter can be produced particularly easily in an injection molding process. This makes particularly easy production of the respective insulating elements and particularly high stability of the insulating elements possible.

In the case of the second embodiment of the coil component 10, provision is thus made for a trapezoidal groove insulation to be used as second insulating elements 30, having beveling toward respective end sides of the support 12, in particular of the laminated core. U-shaped sleeves, which have a wedge-shaped geometry and in the present case the shape of which is designed analogously to the first insulating elements 18 described in connection with the first embodiment, can be arranged in each case on the respective end sides of the support 12. In the case of the second embodiment, there is surface pressure between the wedge geometries of the groove insulation and the phase wires, when installed in the axial end position.

In the case of the second embodiment, it is made possible for a tangential dimension between the groove wedges and the phase wires at the end sides to be able to be adjusted depending on the axial position of the groove wedge. As a result of the surface pressure, there is a particularly high tangential force. Since no groove insulation paper is used in the case of this second embodiment, there is no risk of the groove insulation paper protruding. The coil component 10 of the second embodiment can be disassembled again particularly easily, does not comprise any potting resin, can be manufactured in a particularly short cycle time, has a very high degree of groove filling and makes it possible for the phase wires to be centered in the respective groove 14.

FIGS. 6 and 7 show the third embodiment of the coil component 10, in the case of which the respective hairpins 16 are insulated from respective groove walls, which delimit the associated groove 14, of the support 12 by way of a piece of groove insulation paper 36 as insulating element. The groove insulation paper 36 extends in the axial direction A over an entire height of the groove 14, as a result of which the hairpins 16 arranged in the groove 14 are electrically insulated with respect to the support 12 over the entire height of the groove 14. In the present case, the groove insulation paper 36 has a constant wall thickness over its entire extent. In order to ensure that the groove insulation paper 36 bears particularly tightly against the respective hairpins 16, in order to guarantee a particularly effective transfer of heat as a result, provision is made for respective groove insulation wedges 38, which have the wedge geometry. The groove insulation wedges 38 are each plugged into the respective groove 14 between the groove insulation paper 36 and the wall delimiting the groove 14. This means that the groove insulation wedges 38 bear both against the groove wall delimiting the groove 14 and against the groove insulation paper 36. In the case of the groove insulation wedges 38, the respective side faces adjoining the groove insulation paper 36 and the groove wall converge at an acute angle in the axial direction A. In this case, a pointed edge of the groove insulation wedge 38 is oriented in each case toward a center of the support 12 in the axial direction A. By pushing the groove insulation wedges 38 into the groove 14, the groove insulation paper 36 is thus pressed onto the hairpins 16 in the circumferential direction U. In the present case, in each case at least two pieces of groove insulation paper 36 are arranged in each groove 14 on opposite, in the circumferential direction U, sides of the hairpins 16. The hairpins 16 are thus electrically insulated, on their mutually opposite, in the circumferential direction U, side faces, with respect to the support 12 in each case by a piece of groove insulation paper 36.

In the case of the third embodiment, provision is thus made for two groove insulation wedges 38 per groove 14 and per end side of the support 12. The two groove insulation wedges 38 per end side press the groove insulation paper 36 as third insulating element onto the phase wires of the coil component 10. An axial force during the clamping of the groove insulation wedges 38 is converted into a tangential force acting in the circumferential direction U. In order to make it easier to insert the groove insulation wedges 38 into the respective grooves 14, the groove 14 can have a respective insertion bevel 40 on the respective end sides of the support 12 for each groove insulation wedge 38.

Depending on the axial position of the groove insulation wedges 38, the tangential dimension between the groove insulation wedges 38 and the phase wires on the respective end side of the support 12 can be adjusted. There is surface pressure between the groove insulation wedges 38, the support 12 and therefore in the present case the laminated core and the phase wires, when installed in the end position, which results in a particularly high tangential force in the circumferential direction U. Protrusion of the groove insulation paper 36 is eliminated. The coil component 10 of the third embodiment can be disassembled again particularly easily, does not comprise any potting resin, can be produced in a particularly short cycle time, has a very high degree of groove filling and makes it possible for the phase wires to be centered in the groove 14.

Overall, the present disclosure shows how a wedge-shaped groove insulation for stator windings of electric machines can be used.

### LIST OF REFERENCE SIGNS

10 coil component
12 support
14 groove
16 hairpin
18 first insulating element
20 channel
22 collar
24 stop
26 first end side
28 wedge geometry
30 second insulating element
32 straight portion
34 wedge portion
36 groove insulation paper
38 groove insulation wedge
40 insertion bevel
A axial direction
U circumferential direction
R radial direction

1-9. (canceled)

10. A coil component for an electric machine of a motor vehicle, comprising:
a support comprising a plurality of grooves that are arranged so that they are distributed in a circumferential direction of the support and extend in an axial direction of the support;
a plurality of hairpins, at least portions of which are arranged in the plurality of grooves; and
at least one insulating element arranged in at least a first groove of the plurality of grooves and is configured to electrically insulate at least one hairpin arranged in the first groove from a groove wall of the support that delimits the groove
wherein the insulating element is supported against the groove wall of the support via a wedge geometry, wherein, as a result, a force acting on the wedge geometry in the axial direction is converted into a force acting in the circumferential direction, wherein the force is used to press the insulating element onto the at least one hairpin in the circumferential direction.

11. The coil component according to claim 10,
wherein the insulating element comprises the wedge geometry so that two side faces of the insulating element converge at an acute angle.

12. The coil component according to claim 11,
wherein, in at least the first groove, a plurality of insulating elements are arranged one above the other in the axial direction, and are partially plugged into one another, wherein respective ones of the plurality of insulating elements bear against one another by way of their respective wedge geometries.

13. The coil component according to claim 11,
wherein the insulating element comprises at least one straight portion that runs in the axial direction and has a constant wall thickness, and at least one wedge geometry that adjoins the straight portion in the axial direction.

14. The coil component according to claim 10,
wherein the insulating element has a U-shaped cross section.

15. The coil component according to claim 14,
wherein the first groove is configured for at least two insulating elements, wherein respective arms of the U-shaped cross section of each of the at least two insulating elements are oriented toward one another, wherein the insulating elements jointly enclose a channel that runs in the axial direction and through which the at least one hairpin extends.

16. The coil component according to claim 10,
wherein the insulating element comprises a stop that is configured to abut against an end side of the support and specifies an axial end position of the insulating element.

17. The coil component according to claim 10,
wherein the insulating element is pressed onto the at least one hairpin using a separate groove insulation wedge having the wedge geometry.

18. A method for producing a coil component for an electric machine of a motor vehicle, comprising:
providing a support comprising a plurality of grooves arranged so that they are distributed in a circumferential direction of the support and extend in an axial direction of the support;
arranging a plurality of hairpins and at least one insulating element, at least in portions, in the plurality of grooves, wherein the at least one insulating element electrically insulates the hairpins from a groove wall of the support that delimits the groove; and
supporting the at least one insulating element against the groove wall of the support via a wedge geometry, converting a force acting on the wedge geometry in the axial direction into a force acting in the circumferential direction by way of the wedge geometry, and pressing, using the force, the at least one insulating element onto the hairpins in the circumferential direction.

19. The method according to claim 18,
wherein the insulating element comprises the wedge geometry so that two side faces of the insulating element converge at an acute angle.

20. The method according to claim 19, comprising:
arranging, in at least a first groove of the plurality of grooves, a plurality of insulating elements one above the other in the axial direction so that they are partially plugged into one another, wherein respective ones of the plurality of insulating elements bear against one another by way of their respective wedge geometries.

21. The method according to claim 19,
wherein the insulating element comprises at least one straight portion that runs in the axial direction and has a constant wall thickness, and at least one wedge geometry that adjoins the straight portion in the axial direction.

22. The method according to claim 18,
wherein the insulating element has a U-shaped cross section.

23. The method according to claim 22,
wherein the plurality of grooves are configured for at least two insulating elements, wherein respective arms of the U-shaped cross section of each of the at least two insulating elements are oriented toward one another, wherein the insulating elements jointly enclose a channel that runs in the axial direction and through which the at least one hairpin extends.

24. The method according to claim 18, comprising:
providing a stop on the insulating element that is configured to abut against an end side of the support and specifies an axial end position of the insulating element.

25. The method according to claim 18, comprising:
pressing the insulating element onto the at least one hairpin using a separate groove insulation wedge having the wedge geometry.
